(19) United States
(12) Patent Application Publication
(10) Pub. No.: US 2013/0269525 A1
(43) Pub. Date: Oct. 17, 2013

(54) Absorption Media for Scrubbing CO2 from a Gas Stream and Methods Using the Same

(71) Applicants: Francis R. Alix, Rye, NH (US); Joanna Duncan, Springvale, ME (US); Christopher McLarnon, Exeter, NH (US); Wade Amos, Gloucester, MA (US)

(72) Inventors: Francis R. Alix, Rye, NH (US); Joanna Duncan, Springvale, ME (US); Christopher McLarnon, Exeter, NH (US); Wade Amos, Gloucester, MA (US)

(73) Assignee: POWERSPAN CORP., Portsmouth, NH (US)

(21) Appl. No.: 13/810,378

(22) PCT Filed: May 31, 2011
(86) PCT No.: PCT/US11/38493

§ 371 Date: Feb. 25, 2013

Related U.S. Application Data
(60) Provisional application No. 61/365,918, filed on Jul. 20, 2010.

(51) Int. Cl. B01D 53/14

(52) U.S. Cl. CPC B01D 53/1493; B01D 53/1475
USPC 95/159; 252/184

(57) ABSTRACT

Absorption media for separating acidic gases such as C02 from a gas stream are disclosed. In some embodiments, the Absorption media include a solution of water, at least piperazine or a derivative of piperazine, and at least one alkali ion. The at least one alkali ion may be potassium. Methods and apparatus for separating acidic gases from a gas stream using such absorption media are also disclosed.

The present disclosure relates to absorption media which are useful for scrubbing acidic gases such as CO₂ from a gas stream. Also described are methods for using such absorption media, and methods for scrubbing CO₂ from a gas stream using such absorption media.

### BACKGROUND

Due to its contribution to global warming, carbon dioxide (CO₂) emissions have recently been targeted for similar regulation as other acidic gas (e.g., SOₓ, NOₓ) emissions. CO₂ emissions from the electric power sector account for approximately 40 percent of the total energy related CO₂ emissions in the United States. As roughly 50 percent of U.S. electricity is generated from coal, it is becoming increasingly important that CO₂ capture solutions are developed which are suitable for use in existing coal-burning plants, as well as for planned, new capacity.

It is known in the art that acidic gases such as SO₂, NO₂, and CO₂ can be scrubbed from a gas stream (e.g., coal flue gas) by contacting the gas stream with an aqueous or non-aqueous mixture of inorganic or organic solvents as an absorption medium. Contact between the gas and absorption medium typically occurs in an absorber vessel (e.g., an absorption tower), and results in the absorption of acidic constituents of the gas (e.g., CO₂) into the medium, as well as the production of a scrubbed gas stream. The absorbed acidic gases are later “stripped” from the medium, typically through the application of heat (thermal swing absorption) or a decrease in pressure (pressure swing absorption).

The physical and chemical properties of the absorption medium can affect various operational parameters of the absorption process. Such parameters include, for example, cooling load, total hydrocarbon content (THC) in the scrubbed gas stream, net regeneration energy, CO₂ absorption rate, CO₂ absorption capacity, pumping power for the solvent and gas stream, solvent regeneration rate, solvent vapor loss, solvent degradation, and impurity handling (i.e., reagent recovery). Dependant and competing relationships exist between many of these factors.

For example, increased CO₂ absorption rate is desirable, because it may allow for the use of lower L/G (liquid/gas) ratio during the absorption phase and/or a smaller absorber tower, which may lead to a reduction in capital equipment size (and cost), as well as lower pressure drop in the absorber vessel. However, the absorption of CO₂ by solvents having a high CO₂ absorption rate is often highly exothermic. As a result, significant heat is produced when large quantities of solvent are exposed to significant gas flows, such as in a commercial scale power plant. This excess heat can lead to significant operational challenges, such as solvent vaporization, solvent degradation, increased cooling load, and increased total hydrocarbon content in the scrubbed gas stream, any one of which may lessen or negate the benefits provided by high CO₂ absorption rate.

Significant research has been performed in the art in an attempt to identify a CO₂ absorption medium that exhibits an optimum (or at least commercially viable) balance of the above properties. Pursuant to this research, absorption media based on aqueous solutions of primary, secondary, and tertiary amines and alkanolamines have been developed. Specific examples of such media include aqueous solutions of monoethanolamine (MEA), diethanolamine (DEA), monomethylethanolamine (MMEA), and methyldiethanolamine (MDEA).

Although such media have proven effective for capturing CO₂ from a gas stream in an absorption/stripping process, processes using them are energy intensive. Indeed, the energy consumption of a CO₂ absorption/stripping process using MEA has been reported to be as high as 15-30% of the output of a power plant. MEA and other alkanolamines are also subject to oxidative degradation, thus requiring the capture and processing of resultant waste products, and the periodic addition of fresh amine to the system. Moreover, the THC level in the scrubbed gas stream produced by alkanolamine scrubbing (specifically MEA) is significant, which can lead to permitting problems or dictate the use of an expensive water wash system.

Amine promoted potassium carbonate (K₂CO₃) has also been investigated as a medium for separating CO₂ from a gas stream. Initially, amines were added in catalytic amounts (e.g., <0.5 m) to potassium carbonate for the purpose of improving CO₂ absorption characteristics and kinetics. More recently, research has considered blends of potassium carbonate with high concentrations of amine.

While prior absorption media have shown some promise, to the inventors knowledge none have been able to achieve a satisfactory balance of the competing factors described above, in particular regeneration energy, pumping power, hydrocarbon emissions, and impurity handling. Accordingly, there remains a need in the art for improved absorption media for removing acidic gases from a gas stream, as well as for methods and apparatus utilizing such absorption media. The present disclosure is aimed at satisfying this need.

### SUMMARY

One aspect of the present disclosure relates to absorption media for the removal of acidic constituents of a gas stream, such as carbon dioxide. In a non-limiting embodiment, the aqueous absorption media includes at least one amine (e.g., piperazine), at least one alkali ion, and water.

The concentration of the at least one amine and the at least one alkali ion in the absorption media may vary widely. For example, the at least one amine may be present in an amount ranging from about 8 to about 30 weight %, while the at least one alkali ion may be present in an amount ranging from greater than 0 to about 3.0 weight %. In some non-limiting embodiments, the at least one amine is present in an amount ranging from about 20 to about 26 weight %, and the at least one alkali ion is present in an amount ranging from about 1.5 to about 2.5 weight %. The at least one amine and at least one alkali ion may include piperazine and potassium, respectively, though other amines and alkali ions may also be used.

The composition of the aqueous absorption medium may also be tailored to obtain a desired net regeneration energy in an absorption process for removing CO₂ from a gas stream, such as a thermal swing absorption (TSA) process. As used herein, the term “net regeneration energy” refers to the amount of energy supplied to the regenerator (in BTU/lb CO₂ removed) from external sources only. Thus, “net regeneration energy” is exclusive of energy inputted to or recovered by the regenerator by heat recovery sources, e.g, mechanical vapor recompression, heat exchange, etc. Non-limiting examples of such heat recovery sources are described in U.S. Provisional Application No. 61/357,291, filed Jun. 22, 2010, the contents of which are incorporated herein by reference. In contrast, the term “gross regeneration energy” refers to the amount of energy inputted to the regenerator from external sources and heat recovery sources.

The net regeneration energy in a TSA process using the aqueous absorption media described herein may, for example, be less than about 1300 BTU/lb CO₂ removed. In some embodiments, the net regeneration energy may be less than about 1200 BTU/lb CO₂ removed, less than about 1100 BTU/lb CO₂ removed, or even less than about 1000 BTU/lb CO₂ removed. In some embodiments, the net regeneration energy is less than about 960 BTU/lb CO₂ removed.

Another aspect of the present disclosure relates to methods of using the absorption media described herein. In some embodiments, the methods include contacting a gas stream containing CO₂ with an aqueous absorption medium, wherein the aqueous absorption medium includes at least one amine, at least one alkali ion, and water. The amine concentration may range, for example, from about 8 to about 30 weight % or more. The alkali ion concentration may range, for example from greater than 0 to about 3.0 weight %. Contact between the aqueous absorption medium and the gas stream forms an aqueous absorption medium rich in CO₂ and a scrubbed gas stream.

The methods may further include stripping CO₂ from the aqueous absorption medium rich in CO₂, thereby “regenerating” the absorption media. In some embodiments, the net regeneration energy of the methods described herein is less than 1300 BTU/lb CO₂ removed, such as less than about 1200, 1100, or even 1000 BTU/lb CO₂ removed. In some embodiments, the net regeneration energy may be less than about 960 BTU/lb CO₂ removed.

The methods described herein may also include washing the scrubbed gas stream with an aqueous washing liquid. The aqueous washing liquid may include at least one alkali ion (e.g., potassium) in an amount ranging from greater than 0 to about the solubility limit of the at least one alkali ion in water. In some embodiments, the alkali ion concentration ranges from greater than 0 to about 25 weight % or more, such as about 0.5 to about 5 weight %.

The washing of the scrubbed solution may, for example, serve to reduce the total hydrocarbons present in the scrubbed gas stream. For example, the total hydrocarbon content of the scrubbed gas stream after washing may be less than about 5 ppm. In further non-limiting embodiments, the total hydrocarbon content of the scrubbed gas stream after washing may be less than about 1.0 ppm, such as less than about 0.5 ppm.

Another aspect of the present disclosure relates to an apparatus for removing CO₂ from a gas stream. The apparatus includes, for example, an absorber column and a washing loop. The absorber column includes an inlet for receiving an aqueous absorption medium, a CO₂ absorption section, and a scrubbed gas washing section. The washing loop includes at least one alkali ion feed. The alkali ion feed is configured to supply alkali ions such as potassium ions, to the washing liquid. In operation, the washing loop circulates washing liquid through the scrubbed gas washing section. Within the scrubbed gas washing section, the washing liquid contacts a scrubbed gas stream. After contact with the scrubbed gas stream, the washing liquid is removed for external processing, recirculated through the scrubbed gas washing section, and/or added to the aqueous absorption medium.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 schematically illustrates a thermal swing absorption process.

FIGS. 2A-2D schematically illustrate the integration of a absorption/stripping process with an impurity removal process

FIG. 3 schematically illustrates an absorber tower including absorber intercooling

FIG. 4 schematically illustrates an absorber tower including a water wash system

### DETAILED DESCRIPTION

One aspect of the present disclosure relates to absorption media for the removal of acidic constituents in a gas stream, such as carbon dioxide. The absorption media described herein may, for example, include a mixture of at least one amine, at least one alkali ion, and water.

The concentration of the individual components of the absorption media described herein may vary widely. The at least one amine may be present in an amount ranging from about 8 to about 40 weight % or more. For example, the at least one amine may be present in an amount ranging from about 12 to about 30 weight %, about 15 to about 28 weight %, about 20 to about 26 weight %, or even about 26 to about 30 weight %. In non-limiting embodiments, the concentration of amine in the aqueous amine solvent is about: 8.0, 8.6, 8.8, 9.0, 10.0, 10.7, 11.0, 12.0, 13.0, 14.0, 14.5, 15.0, 16.0, 17.0, 18.0, 19.0, 19.8, 20.0, 21.0, 22.0, 23.0, 23.7, 24.0, and 25.0 weight % or more. Of course, higher or lower amine concentrations may be used, as well as amine concentrations falling within any of the endpoints articulated herein. Indeed, amine concentrations of about: 26.0, 27.0, 28.0, 29.0, 30.0, 35.0, 40.0, 45.0, 50, 55.0, 60.0, 65.0, and 68.0 weight % or more are envisioned by the present disclosure.

Similarly, the concentration of the at least one alkali ion in the aqueous absorption media may vary over a considerable range. For example, the at least one alkali ion may be present in an amount ranging from greater than 0 to about 3.0 weight % or more. In some embodiments, the concentration of alkali ion (e.g., potassium) in solution ranges from: about 0.1 to about 2.9 weight %, about 0.5 to about 2.5 weight %; about 1.0 to about 2.3 weight %; about 1.5 to about 2.5 weight %, or even about 2.0 to about 2.3 weight %. Of course, the concentration of the at least one alkali ion may be above, below, or within any of the above mentioned endpoints. Indeed, alkali ion concentrations of 5.0, 10, 15, and 20 weight % or more are envisioned by the present disclosure.

The at least one amine may be chosen from a variety of cyclic, linear, primary, secondary, or tertiary amines. Non-limiting examples of suitable amines include piperazine, substituted piperazines and piperazine derivatives, such as N-(2-hydroxyethyl)piperazine, N-(hydroxypropyl)piperazine, and aminoethylpiperazine, ethylenediamine, dimethyl ethylenediamine, pyrazolidine, imidazole, 2-methylimidazole, 4-methylimidazole, imidazolidine, 2-(2-pyrrolidyl)pyrrolidine, 2-(2-imiazlidyl)imidazolidine, 3-(3-pyrrolidyl)piperidine, 3-(2-piperazinyl)piperidine, 2-(2-piperazinyl)piperazine, monoethanolamine (MEA), diethanolamine (DEA), monomethylethanolamine (MMEA), methyldiethanolamine (MDEA), and mixtures thereof. In some embodiments, the at least one amine includes piperazine, either alone or in combination with other amines.

The at least one alkali ion may be chosen, for example, from the ions of group IA and IIA metals, and ammonium (NH₄⁺). As non-limiting examples, mention is made of sodium, potassium, lithium, rubidium, cesium, francium, magnesium, calcium, and ammonium (NH₄⁺) ions, and mixtures thereof. In some embodiments, the at least one alkali ion is chosen from sodium ions, potassium ions, lithium ions, and mixtures thereof. In non-limiting embodiments, the at least one alkali ion includes potassium ions, either alone or in combination with other alkali ions.

Alkali ions may be added to the aqueous absorption media via any means, such as by the addition of an alkali salt. Non-limiting examples of suitable alkali salts include carbonates, bicarbonates, halides, and hydroxides of the alkali ions described herein. For example, if the alkali ions to be added are potassium, lithium, or sodium ions, such ions may be added via the addition of the corresponding carbonate (i.e., potassium, sodium, and/or lithium carbonate), bicarbonate (i.e., potassium, sodium, and/or lithium bicarbonate), chloride (e.g., potassium, sodium, and/or lithium chloride), and/or hydroxide (i.e., potassium, sodium, and/or lithium hydroxide). Of course, alkali ions may be introduced via other known salts, such as sulfates, sulfides, bisulfides, halides other than chlorides, etc., as desired.

As described previously, the physical and chemical properties of the absorption medium may affect various operational parameters of a CO₂ absorption/stripping process. Such parameters include, for example, cooling load, total hydrocarbon content (THC) in the scrubbed gas stream, regeneration energy, CO₂ absorption rate, CO₂ absorption capacity, solvent regeneration rate, solvent vapor loss, solvent degradation, and impurity handling (i.e., reagent recovery).

The inventors have found that desirable values for one or more of these factors may be obtained by adjusting the concentration of the amine(s) and alkali ion(s) in an absorption medium. In some instances, it is possible to achieve a desired balance between two or more of these competing variables. This balance can lead, for example, to a CO₂ absorption/stripping process that exhibits improved performance at lower cost. For illustrative purposes, a discussion of the impact of amine and alkali ion concentration on several aspects of an absorption/stripping process is provided below, using a non-limiting exemplary absorption medium containing piperazine as the amine.

Absorption of CO₂ by piperazine occurs exothermically, with a heat of absorption of about −17 to −22 kcal/g mol. Thus, when an absorption medium comprising piperazine is used in an absorption/stripping process for capturing CO₂, such as a thermal swing absorption process, significant heat is generated during contact with a gas stream in the absorber, raising temperature. This temperature rise can lead to a non-uniform temperature profile (i.e., a temperature “bulge”) in the absorber. That is, the temperature profile of the absorber can show a peak temperature (“bulge”) towards the interior of the absorber, with lower temperatures nearer to the absorber's liquid inlet and outlet.

As piperazine concentration increases, the maximum temperature in the absorber can increase. This increased temperature encourages vaporization of piperazine from the absorption medium. Left unchecked, the vaporized piperazine can be emitted into the atmosphere with the scrubbed gas stream. Due to strict permitting requirements with regard to hydrocarbon emissions, it may be necessary to capture (e.g., via a water wash) or otherwise address this vapor (e.g., via absorber intercooling) before it exits the absorber vessel with the scrubbed gas stream. Moreover, replacement of the piperazine exiting with the scrubbed gas stream may be needed to maintain scrubbing performance, leading to an increase in operating expense.

An additional consideration posed by high temperature in the absorber is water vaporization. As temperature in the absorber increases (e.g., due to heat of absorption), significant water vaporization may occur. As water vaporization increases, additional makeup water and water condensation may be required to maintain the water balance of the system.

Despite the challenges associated with the use of piperazine, absorption media containing a high concentration of piperazine may be desirable. Specifically, as piperazine concentration increases, the rate of CO₂ absorption and the CO₂ absorption capacity of the absorption medium also increase. Moreover, increasing piperazine concentration can reduce regeneration energy, potentially leading to a lower net regeneration energy requirement (in BTU/lb CO₂ removed). Finally, higher piperazine concentrations may permit the use of lower L/G ratios due to increased solution capacity, while still retaining the ability to remove a 90% or more of the CO₂ in a gas stream. In addition to reducing regeneration energy, this reduction in L/G can lead to reduced pressure drop and/or a reduction in the size of various capital components (e.g., absorber tower, pumps, heat exchangers, etc.), opening avenues to significant cost savings.

The maximum concentration of piperazine may be determined, for example, by the solubility of piperazine in the absorption medium at the operating conditions of the process, or by the impact of higher concentrations on the amount of gas-liquid contact (mass transfer) required to achieve a desired level of CO₂ removal. At elevated piperazine and alkali ion (e.g., potassium) concentration, the absorption medium can have a substantially higher viscosity, and gelling and solidification of the absorption medium can occur. This may dictate an increase in absorber tower height and/or the use of increased pumping power to facilitate adequate heat and/or mass transfer, any of which may add to the capital equipment cost and operating expenses of the system.

The inventors have found that as piperazine concentration increases, solubility can be maintained by decreasing alkali ion concentration. Put in other terms, the inventors have unexpectedly found that by maintaining a high ratio of piperazine (weight %) to alkali ion (weight %), it is possible to obtain a soluble absorption medium containing elevated concentrations of piperazine. In addition, heat, dilution, or a solubility enhancing additives may be added for the purpose of keeping the piperazine in solution, or to maintain the absorption medium in the liquid phase.

As examples of suitable piperazine to alkali ion ratios (weight %:weight %) that may be used in accordance with the present disclosure, non limiting mention is made of about: 3.5:1.0, 4.0:1.0, 4.5:1.0, 5.0:1.0, 6.0:1.0, 7.0:1.0, 8.0:1.0, 9.0:1.0, 10.0:1.0, 11.0:1, 12.0:1, 12.5:1.0, 13.0:1.0, 14.0:1.0, 15.0:1.0, 20.0:1.0, 25.0:1.0, 30.0:1.0, 50.0:1.0, 100.0:1.0, and 1000.0:1.0 or more. In some embodiments, the weight % ratio of piperazine to alkali ion is greater than about 3.6:1.0, 3.7:1.0, 3.8:1.0, or even 3.9:1.0. Ratios that are higher, lower, and within the above ratios may also be used, and are envisioned by the present disclosure.

Accordingly, piperazine concentration presents a tradeoff between several competing factors. Specifically, lower piperazine concentrations can lead to one or more of reduced volatility, smaller temperature bulge, lower H₂O makeup requirements, and reduced flue gas pressure drop, but may require the use of higher L/G ratios and/or higher regeneration energies. In contrast, high piperazine concentrations can lead to one or more of increased volatility, temperature bulge, and water evaporation, but may exhibit enhanced CO₂ absorption rate, reduced regeneration energy, and/or increased capacity, which may permit the use of lower L/G ratio. These and other impacts of piperazine concentration are described in the examples and tables provided below.

When an absorption/stripping process such as thermal swing absorption process is used to treat a gas stream, impurities such as sulfate, nitrate, chloride, etc. are often absorbed into the absorbing medium in addition to acidic gas constituents such as carbon dioxide. If these impurities are allowed to build, they can present several problems. For example, high chloride levels (e.g., >1000 ppm) in the absorption medium can lead to corrosion, which may dictate the use of more expensive corrosion resistant materials or corrosion inhibitors. Furthermore, because sulfate has limited solubility in the absorption medium, building sulfate concentration in the absorption medium can lead to undesirable precipitation in the absorber.

By controlling the concentration of alkali ions such as potassium in the absorption medium, it is possible to address many of the complications introduced by the above mentioned impurities. In particular, the addition or maintenance of at least a certain concentration of alkali ions can enable the separation of sulfates, nitrates, and/or chlorides from the absorption medium. That is, the presence of alkali ions may enable the removal of alkali sulfates, alkali nitrates, alkali chlorides, ions thereof, and mixtures thereof. Removal of such impurities from the absorption medium may be accomplished, for example, by crystallization, precipitation, ion exchange, a combination thereof, and/or another separation technique. Where potassium is present in the absorption medium, it may be possible to crystallize potassium sulfate. In some instances, this may permit the dual benefit of removing impurities from the absorption medium while producing a saleable fertilizer product (namely K₂SOₓ). In addition, this may also serve to reduce or limit the loss of expensive amine (e.g., piperazine), as impurities tend to preferentially combine with the alkali ion if they are allowed to build to substantial concentration.

The concentration of alkali ions in the absorption medium may, for example, be determined by the impurity concentration in the absorption medium. In some embodiments, the alkali ion concentration ranges from greater than 0 to about 3.0 weight % or more. For example, the concentration of alkali ions may be greater than 0, 0.1, 0.2, 0.3, 0.4, 0.5, 0.6, 0.7, 0.8, 0.9, 1.0, 1.1, 1.2, 1.2, 1.3, 1.4, 1.5, 1.6, 1.7, 1.8, 1.9, 2.0, 2.1, 2.1, 2.3, 2.4, 2.5, 2.6, 2.7, 2.8, 2.9, or 3.0 weight % or more. Of course, the concentration of alkali ions may be higher, lower, or within any of the above noted endpoints. In some embodiments, the alkali ion concentration (e.g., potassium ion concentration) is determined by the solubility limit of sulfate, nitrate and/or chloride in the absorption medium.

In the case of potassium, the inventors have found that regeneration energy tends to increase as potassium concentration in the absorption media increases. Thus, in addition to negatively impacting the solubility of piperazine (as noted above), increased alkali (potassium) concentration can have a negative impact on regeneration energy. Accordingly, while the presence of alkali ion (e.g., potassium) in the absorption medium can lead to the beneficial properties stated above, the total concentration of alkali ion may be limited by its impact on regeneration energy and amine solubility.

For the foregoing reasons, alkali ion concentration presents a tradeoff between several competing factors, particularly where potassium is used. Specifically, the presence of some amount of alkali ions in solution may permit the beneficial separation of impurities without significant loss of the amine. And in the case of potassium, the presence of alkali ions may allow the production of a valuable fertilizer coproduct. However, elevated alkali ion concentrations may also increase regeneration energy and/or limit the solubility of the amine (e.g., piperazine) in the absorption medium. These and other impacts of alkali concentration are illustrated in the examples and tables provided below.

In view of the tradeoffs described above, another aspect of the present disclosure relates to absorption media for removing CO₂ from a gas stream, wherein both alkali salt and amine concentration in the media are controlled. In one non-limiting embodiment, the amine concentration ranges from about 8 to about 30 weight %, and the alkali ion ranges from greater than 0 to about 2.5 weight %. In another non-limiting embodiment, the amine concentration ranges from about 15 to about 28 weight %, and the alkali ion concentration ranging from about 1.5 to about 2.5 weight %. In further non-limiting embodiments, the amine (e.g., piperazine) concentration ranges from about 20 to about 26 weight %, and the alkali ion (e.g., potassium) concentration ranges from about 1.5 to 2.5 weight %. In specific non-limiting examples, the amine concentration is about 22, 24, 26, or 28 weight %, and the amount of alkali ion is about 2 weight %. Of course, other combinations of amine and alkali are envisioned by the present disclosure. Indeed, combinations of amine and alkali ion, wherein each is present in an amount corresponding to any endpoint recited in this application, or within any combination of such endpoints, may be used.

Additives commonly used in the art such as antifoaming agents, stabilizers, antioxidants, corrosion inhibitors, etc. may also be included the absorption media described herein. As examples of antifoaming agents that may be used, non-limiting mention is made of DOW CORNING® Q2-3183A and DOW® UCARSOL™, which are commercially available. The amount of each additive may range, for example, from 0 to about 5% by weight, such as from about 0.01 to about 1 weight %. In some embodiments, the total concentration of additives is less than about 10 weight %, such as less than about 5 weight %, or even less than 1 weight %. Of course, more or less additives may be added to the absorption media described herein, as warranted by the composition of the media and/or process conditions.

The absorption media of the present disclosure may optionally contain one or more monohydric or polyhydric alcohols, e.g., as part of an antifoaming agent. As an example of an polyhydric alcohol that may be used, non-limiting mention is made of octylphenoxy polyethoxy ethanol, which is contained in the DOW CORNING® Q2-3183A antifoam, as reported in Dow Corning (Shanghai) Co. Ltd. Material Safety Data Sheet, DOW CORNING® Q2-3183A Antifoam, Version No. 2.1 (Dec. 29, 2005).

The amount of mono or polyhydric alcohol that may be used can range from 0 to less than 1 weight %. In some embodiments, the amount of mono or polyhydric alcohol may range from greater than 0 to less than 1 weight %, such as from about 0.000001 to about 0.8 weight %, about 0.00001 to about 0.7 weight %, about 0.0001 to about 0.6 weight %, about 0.001 to about 0.5 weight %, or even about 0.01 to 0.3 weight %. Of course, concentrations of mono or polyhydric alcohol above, below, or within any of the aforementioned endpoints may be used.

While the present disclosure generally discusses the removal of carbon dioxide from a gas stream, other acidic gases which are capable of being removed by the aqueous absorption media described herein are contemplated. Such acidic gases include, for example, H₂S, SO_{X}, NOₓ, COS, CS₂, HCl, HF, and mercaptans.

As used herein, the term “gas stream” encompasses gas streams produced from any source. Non-limiting examples of gas streams include those produced as a by-product of a chemical process, such as the thermal degradation or combustion of fossil fuels (e.g., coal, oil, natural gas), biomass combustion or degradation (e.g., landfill gas), petroleum refining, fermentation, etc. In some embodiments, the gas stream is flue gas produced by a coal-fired power plant.

Another aspect of the present disclosure relates to methods for removing carbon dioxide from a gas stream using the absorption media described herein. In some embodiments, the disclosed methods include contacting a gas stream with an aqueous absorption medium, wherein the aqueous absorption medium includes from about 8 to about 30 weight % of at least one amine, from greater than 0 to about 3.0 weight % of at least one alkali ion, and water. In further non-limiting embodiments, the at least one amine is piperazine, and the at least one alkali ion is potassium.

In some embodiments, the absorption media described herein are used in an absorption/stripping process for capturing acidic gases from a gas stream such as a thermal or pressure swing absorption process. For example, the aqueous absorption media described herein may be introduced into an absorber (e.g., an absorber tower) of a thermal swing absorption process. Within the absorber, the absorption media contacts a gas stream. During this contact, the absorption medium removes acidic gases (e.g., CO₂) from the gas stream, producing a rich absorption medium and a scrubbed gas stream. The scrubbed gas stream exits the absorber, after which it may be further processed or released into the atmosphere. The rich absorption medium is conveyed to a stripping vessel, such as a stripper column. The stripping vessel is configured to promote the separation of CO₂ from the rich absorption medium, thereby producing a regenerated absorption medium and an offgas comprising CO₂. The stripping vessel may promote the separation of CO₂ from the rich absorption medium via any known means in the art, such as the application of heat, a pressure drop, etc.

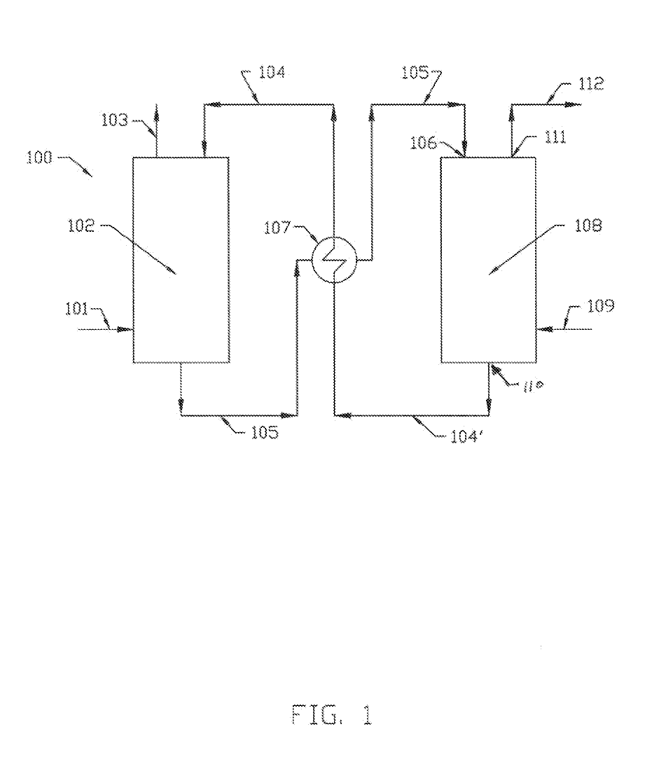

As a non-limiting example of a method in accordance with the present disclosure, attention is drawn to FIG. 1, which schematically illustrates a thermal swing absorption process 100 for removing carbon dioxide from a gas stream, such as flue gas from a power plant. In this process, gas stream 101 (e.g., flue gas) enters a bottom portion of absorber column 102. Within absorber column 102, gas stream 101 comes into contact with a CO₂ lean absorption medium 104. CO₂ lean absorption medium 104 includes at least one amine, at least one alkali ion, and water.

In some embodiments, the at least one amine is chosen from piperazine and piperazine derivatives, and the at least one alkali ion is chosen from sodium, potassium, and lithium ions. In further non-limiting embodiments, the at least one amine is piperazine, and the at least one alkali ion is potassium. The concentration of the at least one amine and at least one alkali ion may be in accordance with any of the endpoints and ranges discussed herein. In some embodiments, CO₂ lean absorption medium 104 includes from about 8 to about 30 weight %, such as about 20 to about 28 weight % of piperazine, and from greater than 0 to about 3 weight % (e.g., about 2 to about 2.5 weight % of potassium ions. In further non-limiting embodiments, CO₂ lean absorption medium 104 includes about 22 to about 28 weight % of piperazine, and about 2 weight % of potassium ions.

During contact with gas stream 101, CO₂ lean absorption medium 104 absorbs CO₂ from gas stream 101, thereby producing CO₂ rich absorption medium 105 and scrubbed gas stream 103. CO₂ rich absorption medium 105 exits absorber column 102 and is conveyed through heat exchanger 107 to a liquid entrance 106 of regenerator column 108. Within regenerator column 108, CO₂ rich absorption medium 105 is heated to evolve offgas 112, thereby producing regenerated CO₂ lean absorption medium 104′. If the process is implemented to capture CO₂ from the flue gas of a coal-fired power plant, the heat required to for the regeneration process may, for example, be supplied by a steam feed 109 from the plant.

Steam feed 109 either provides “stripping” steam to the regenerator column (i.e., steam directly injected into the column), or is used to heat liquid within the regenerator column (e.g. via reboiling). As an example of the latter method, liquid may be removed from the regenerator column and passed through a heat exchanger, where it picks up heat (e.g., from a steam feed from the plant). Heating of the liquid may proceed with or without boiling. For example, heating may be performed in a boiler, such as a kettle boiler, thereby producing steam which is reintroduced into the regenerator. Alternatively, heating may occur under conditions that prevent boiling (e.g., under pressure), after which the resulting hot liquid is reintroduced into the regenerator column. In a non-limiting embodiment, liquid from the regenerator is heated in a kettle boiler to produce steam, which is reintroduced into the regenerator column. Heating may also occur within the regenerator column itself.

Offgas 112 includes water vapor and carbon dioxide, and exits regenerator column 108 via vapor exit 111. Offgas 112 may be subject to further processing, such as drying and compressing. In some embodiments, Offgas 112, is dried (e.g., with a condenser) and compressed for use in other processes (not shown). Regenerated CO₂ lean absorption medium 104′ exits regenerator column 108 via liquid exit 110, and is recirculated to absorber column 102 for reuse in the absorption process.

Use of the absorption media described herein may permit the adjustment of several operational parameters in a stripping/absorption process, such as the thermal swing absorption process described above. For example, the absorption media described herein may permit the use of a lower L/G ratio in the absorption phase, i.e., during contact between a gas stream and the absorption medium. In some embodiments, the L/G ratio in the absorption phase may range from greater than 0 to less than about 40 gpm/kacfm, such as from about 10 to about 30 gpm/kacfm, or even about 15 to about 25 gpm/kacfm. In some embodiments, the L/G during the absorption phase is about 10, 11, 12, 13, 14, 15, 16, 17, 18, 19, 20, 21, 22, 23, 24, 25, 26, 27, 28, 29, or 30 gpm/kacfm. Of course, L/G ratios above, below, or within the aforementioned endpoints and ranges may be used, as dictated by the process.

Use of the absorption media and methods described herein may also permit the attainment of a desired net regeneration energy of CO₂ capture (BTU/lb CO₂ removed). In some embodiments, the net regeneration energy is less than about 1900, 1800, 1700, 1600, 1500, 1400, 1300, 1200, 1100, 1000, or even 960 BTU/lb CO₂ removed. In a non-limiting embodiment, the absorption media described herein are used in a thermal swing absorption process to capture CO₂ from a gas stream, and the net regeneration energy is less than about 1300 BTU/lb CO₂ removed. In such embodiments, the absorption may include, for example, about 20 to about 22 weight % piperazine and about 2 to about 2.2 weight % potassium ions. Of course, net regeneration energies within, above, or below the aforementioned endpoints may be obtained, and are envisioned by the present disclosure.

As previously explained, the gas stream to be treated may include, in addition to CO₂, other components such as SO₂, NOₓ, and halogen containing compounds such as chlorides. These “impurities” may be absorbed into the absorption media described herein during contact with the gas stream. The form the impurity will take in the absorption media can vary based on fuel composition, absorption media composition, and absorption conditions. However, it is frequently the case that the absorption of SO₂ and NO will result in the formation of sulfates and nitrates in the absorption medium. Similarly, absorption of halogen containing compounds often results in the presence of free halogens or halogen containing compounds in solution, such as free chloride or chlorine containing compounds. The impact of these impurities has been described previously, and is not repeated here.

In some embodiments, the methods described herein may include one or more steps to remove at least one impurity from the absorbing medium. For example, the methods described herein may include one or more steps for removing sulfates, nitrates, chlorides and/or a combination thereof. Any removal means known in the art may be appropriately used for this purpose, and the specific means utilized may depend on the composition of the absorption medium and the composition of the impurities selected for removal. For example, the methods described herein may remove sulfates from the absorption media by crystallization and/or precipitation.

Crystallization and/or precipitation may be performed in a crystallizer, a thermal reclaimer or by another means. The crystallized product may, for example, include a sulfate of the at least one alkali ion in the absorption media. That is, the crystallized product may include sodium, potassium, lithium, rubidium, cesium, or francium sulfate, or a mixture thereof. In some embodiments, the absorption medium includes potassium ions, and the crystallized product includes potassium sulfate.

Sulfates, nitrates, and halogens (chloride) may also be removed by exposing the contaminated absorption medium to an ion exchange resin. The ion exchange resin may be a cationic, anionic, or amphoteric resin. In some embodiments, the ion exchange resin is chosen from anionic resins and amphoteric resins. As an example of suitable amphoteric resins that may be used in accordance with the present disclosure, non-limiting mention is made of the DOWEX amphoteric resins sold by DOW. Regeneration of the ion exchange resin may be performed with any known regeneration liquid, such as water, a strong acid, or a strong base (e.g., alkali hydroxides such as NaOH, KOH, etc.).

Of course, impurities may be removed from the absorption media described herein using a combination of removal techniques. For example, a combination of crystallization/precipitation and ion exchange may be used to remove sulfates, nitrates, and/or halogen impurities from the absorption media. In some embodiments of the methods described herein, at least some impurities are removed via crystallization followed by ion exchange. In other non-limiting embodiments, at least some impurities are removed via ion exchange followed by crystallization. In still further non-limiting embodiments, crystallization and ion exchange may be used to remove impurities from separate streams of absorption media.

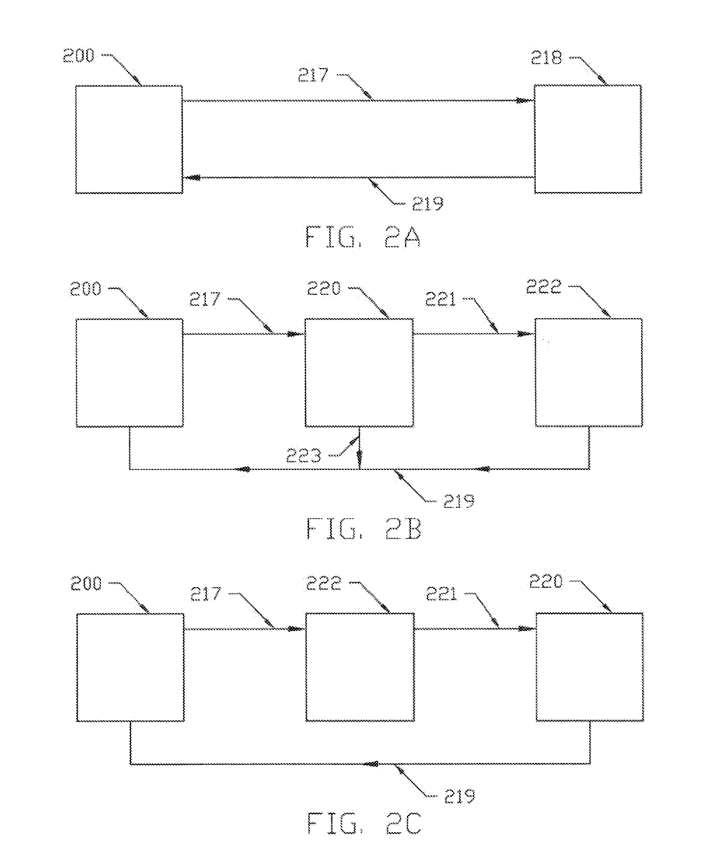

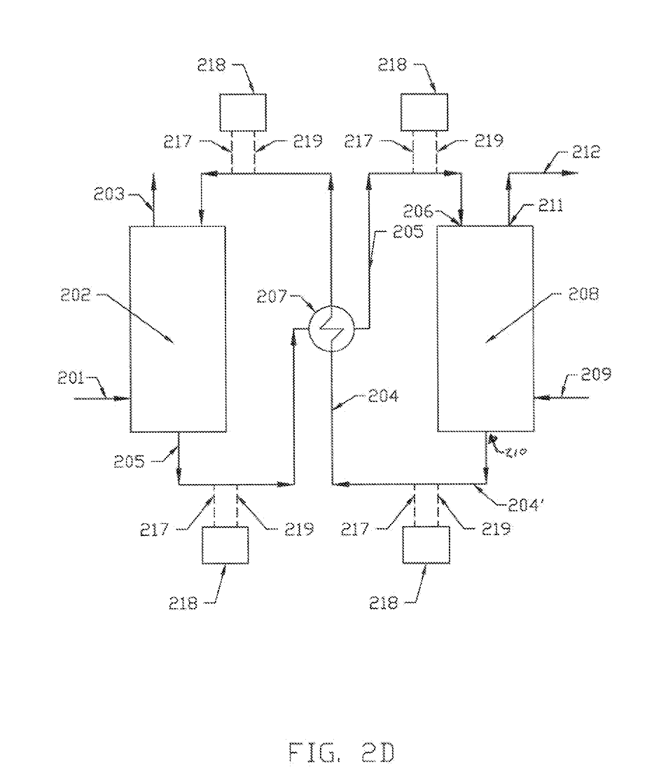

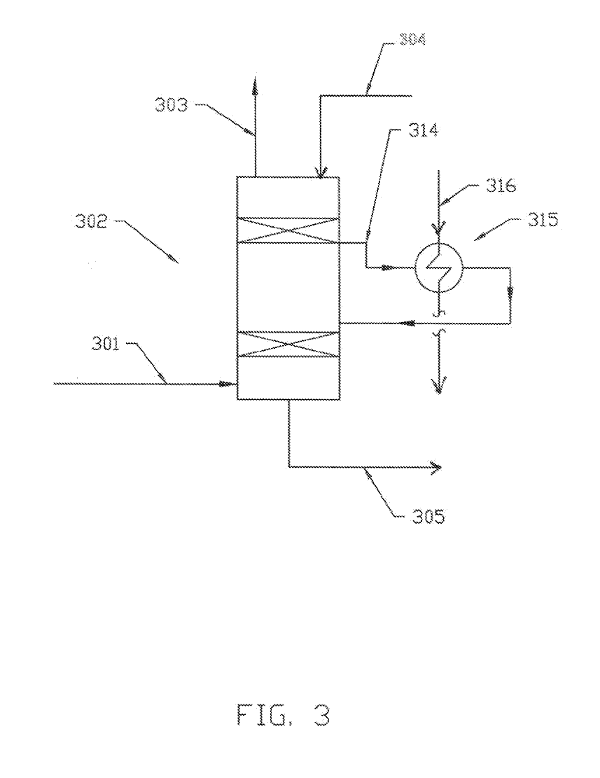

FIGS. 2A-2D are non-limiting exemplary flow diagrams showing the interaction between and configuration of an absorption/stripping process 200 and an impurity removal system 218. As shown in FIG. 2A, an absorption medium rich in impurities is conveyed, via flow 217, from absorption/stripping process 200 (e.g., the thermal swing absorption process illustrated in FIG. 1) to an impurity removal system 218. Within impurity removal system 218, at least a portion of the impurities are removed from the absorption medium rich in impurities, thereby forming an absorption medium lean in impurities and a by-product stream (not shown). The absorption medium lean in impurities is then conveyed, via flow 219, back to the absorption/stripping process.

FIGS. 2B and 2C show two non-limiting variations of impurity removal system 220 in accordance with the present disclosure. In FIG. 2B, absorption medium rich in impurities is conveyed, via flow 217, to crystallizer 220. Within crystallizer 220 at least one impurity (e.g., a sulfate such as potassium sulfate) crystallizes/precipitates, and is separated from the absorption medium by a by-product stream (not shown). A portion of the absorption medium is then conveyed, via flow 221, to contact ion exchange resin 222. Another portion of the absorption medium is returned to absorption stripping process 200 via flow 223.

Ion exchange resin 222 binds to additional impurities within the absorption medium. The resulting absorption medium lean in impurities is then returned via flow 219 to absorption/stripping process 200. Regeneration of the ion exchange resin produces a by-product stream (not shown) which contains the impurities separated from the absorption medium. FIG. 2C is substantially similar to FIG. 2B, except that the absorption medium rich in impurities is contacted with ion exchange resin 222 before it enters crystallizer 220.

One potential advantage of crystallizing before ion exchange is that it allows the feed to the ion exchanger to be taken from the crystallizer. This allows the concentration of uncrystallized impurities such as chloride to build to higher concentration before a portion of the absorption medium is passed to the ion exchange resin. Moreover, free sites on the resin bed that would have bound to the impurities removed via crystallization (e.g., sulfates) remain available to bind un-crystallized impurities such as chloride. This may permit the use of a smaller ion exchange system that requires less liquid to regenerate.

FIG. 2D highlights some possible configurations for integrating impurity removal system 218 into an absorption/stripping process 200, such as a thermal swing absorption process. In this FIG., elements 200-212 are identical to elements 100-112 of FIG. 1, and so are not described herein.

As shown, one or more than one impurity removal system 218 may be used to remove impurities from the absorption medium. For example, impurity removal system 218 may be configured to remove impurities from all or a portion of lean absorption medium 204, all or a portion of rich absorption medium 205, or a combination thereof. As illustrated, impurity removal system is configured to remove a portion of absorption medium rich in impurities from one or more of flows 204 (lean absorption medium) and 205 (rich absorption medium) via flow 217. After the impurity removal system removes at least some impurities from the absorption medium rich in impurities, the resulting absorption medium lean in impurities is returned to absorption/stripping process 200 via flow 219.

It should be noted that the hashed lines designating flows 217 and 219, and impurity removal system 218 indicate that impurity removal system 218 and flows 217 and 219 are optionally placed at their illustrated locations. One of ordinary skill in the art will understand and appreciate that impurity removal may be integrated into other parts of the absorption/stripping process, and that multiple impurity removal systems may be used for the purposes of redundancy, to ensure adequate treatment capacity, etc.

As previously explained, the exothermic absorption of CO₂ by the absorption media described herein can cause a temperature bulge in the absorber, with increasing amine concentration leading to a corresponding (though not necessarily 1:1) increase in temperature. As the maximum temperature in the absorber increases, increasing amounts of water and amine can vaporize from the absorption medium. These vapors can leave the absorber with scrubbed gas stream, affecting the water balance and/or performance of the system. To address this issue, some embodiments of the present disclosure include features which prevent or limit the vaporization of amine, and/or which capture vaporized amine prior to its emission into the atmosphere.

One non-limiting method of ameliorating or limiting the vaporization of water and/or amine in the absorber is absorber intercooling. Various methods of absorber intercooling are known in the art, and all are envisioned as suitable for use with the methods described herein. In some embodiments of the present disclosure, absorber intercooling includes removing a portion of hot absorption medium from the absorber, cooling it, and returning the cooled absorption medium to the absorber. Cooling the portion of hot absorption medium may be performed by any means. For example, cooling may be performed by passing the portion of hot absorption medium through a heat exchanger cooled with a heat transfer liquid (e.g., cooling water). This decrease in temperature reduces both the hydrocarbon release from the absorption medium, and the amount of water vapor leaving the absorber. It may also increase the absorption capacity of the absorption medium. As the temperature bulge in the absorber increases, additional intercooling may be needed to maintain water balance and minimize hydrocarbon release.

As a non-limiting example of an absorber including absorber intercooling in accordance with the present disclosure, reference is made to FIG. 3. As shown, gas stream 301 enters a bottom portion of absorber column 302. As gas stream 301 travels upwards through absorber column 302, it comes into counter current contact with lean absorption medium 304. Absorption of CO₂ by lean absorption medium 304 occurs exothermically, raising temperature in absorber column 302. Stream 314, which may be all or a portion of the resulting hot absorption medium, is removed (e.g., via separator trays, not shown) from absorber tower 302. Stream 314 is conveyed through heat exchanger 315, where it is cooled by exchanging heat with liquid flow 316. The resulting cooled absorption medium is then returned to absorber tower 302.

Another method for limiting or eliminating amine vapor loss is by washing the scrubbed gas stream prior to its emission into the atmosphere. Washing of the scrubbed gas stream (e.g., with water) is commonly used in ammonia based processes for capturing CO₂. In such processes, ammonia tends to vaporize during CO₂ absorption and “slip” out of the absorber with the scrubbed gas stream. To capture the ammonia vapor before it exits the absorber, the scrubbed gas stream is washed with a washing liquid, such as water.

The principles and techniques associated with these prior known washing techniques are largely applicable to the methods of the present disclosure. However, in cases where the absorption medium contains piperazine and/or piperazine derivatives, the inventors have unexpectedly discovered that that washing performance is markedly improved by the controlled addition of alkali ions to the washing solution, as illustrated in the examples below.

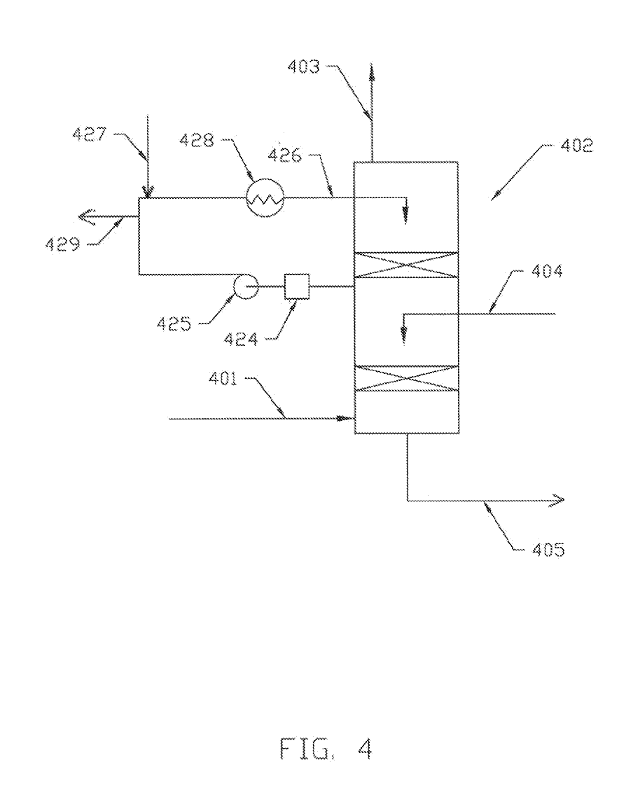

As an example of a washing process in accordance with the present disclosure, reference is made to FIG. 4. As shown, gas stream 401 enters a bottom portion of absorber column 402, and lean absorption medium 404 enters an upper portion of absorber column 402. Gas stream 401 comes into counter current contact with lean absorption medium 404, producing rich absorption medium 405 and scrubbed gas stream 403. Scrubbed gas stream 403 flows upwards and eventually exits absorber column 402.

Prior to exiting absorber column 402, scrubbed gas stream 403 is washed with a washing liquid that is introduced by a liquid distribution means (not shown), such as spray nozzles or distribution trays to remove or reduce the amount of amine in scrubbed gas stream 403. The washing liquid is supplied by washing loop 426 and pump 425. The washing loop may optionally include a tank 424, as shown. An alkali ion feed 427 supplies a controlled amount of alkali ions to the washing liquid, e.g., by addition to washing loop 426 (as shown), and/or to optional tank 424 (not shown). In some embodiments, alkali ions are added after an optional bleed stream 429, which removes a portion of the contaminated washing liquid from washing loop 426 for external processing, disposal, and/or addition to the absorption medium. Of one of ordinary skill in the art will understand from this description that alkali ions may be added to the washing liquid at any point along washing loop 426, as permitted by the system.

The washing liquid containing alkali ions is optionally cooled, e.g., by cooler 428 prior to being supplied to absorber 402. After washing scrubbed gas stream 403, the washing liquid is collected by separator trays or another liquid collection means (not shown) and returned to washing loop 426.

As an example of a suitable washing liquid that may be used in accordance with the present disclosure, non-limiting mention is made of aqueous washing solutions comprising a combination of water and alkali ions, such as sodium, potassium, and or lithium ions. In some embodiments, the washing solution includes water and potassium ions. The amount of alkali ions in the washing solution may range from greater than 0 to up to the solubility limit of the alkali ions. For example, the amount of alkali ions may range from greater than 0 to about 30 weight % or more, such as from about 1 to about 3 weight %, and from about 2 to about 3 weight %. Of course, other alkali ions and ion concentrations may be used, and are contemplated herein. In some non-limiting embodiments, the washing liquid according to the present disclosure contains about 5, 7.5, 10, 12.5, 15, 20, 25, 30, 35, 40, 45, 50 weight % or more of alkali ions, such as potassium.

The washing liquid may also have a pH that is a desired value. For example, the washing liquid may be of acidic pH (pH<7), neutral pH (pH equal to 7) or of basic pH (pH>7). In some embodiments, the pH of the washing liquid may be greater than about 7, 7.5, 8, 8.5, 9, 9.5, 10, 10.5, 11, 11.5 12, 12.5, 13, 13.5 and/or 14. The pH of the washing liquid may also range between any of the aforementioned endpoints, e.g., from about 7 to about 14, from about 8 to about 12, about 9 to about 11, or even from about 9 to about 10.5. Of course, endpoints and ranges above, below, and within the foregoing endpoints and ranges are envisioned by the present disclosure.

The washing of the scrubbed solution may, for example, serve to reduce the total hydrocarbons present in the scrubbed gas stream. In some non-limiting embodiments, the total hydrocarbon content of the scrubbed gas stream after washing is less than about 100 ppm, 50 ppm, and/or 5 ppm. In further non-limiting embodiments, the total hydrocarbon content of the scrubbed gas stream after washing is less than about 1.0 ppm, such as less than about 0.5 ppm.

In addition, when an absorption medium comprising potassium and piperazine is utilized, a washing liquid containing potassium ions can exhibit another distinct advantage over other washing liquids. That is, by using a washing liquid containing potassium, it is possible to capture all or almost all of the piperazine vapor in the scrubbed gas stream before it exits the absorber. Moreover, the resulting washing liquid will be a mixture of potassium, piperazine, and water, i.e., the same primary components of the absorption medium itself. As a result, disposal of the washing liquid is not necessary. Rather, the washing liquid may be added directly to the absorption medium, with minimal or no processing to remove potassium or other constituents of the washing liquid.

It should be understood that the configuration of the absorber column shown in FIGS. 3 and 4 is presented for illustrative purposes only, and does not include all the details of a full design that would be appreciated and understood by one of ordinary skill in the art. For example, FIGS. 3 and 4 do not illustrate the sprays and various flows that are commonly found in absorption columns, all of which are envisioned by the present disclosure. Moreover, one of ordinary skill would understand that in FIG. 4, optional tank 424, cooler 428, and bleed 429 are optional components.

Other than in the examples, or where otherwise indicated, all numbers expressing endpoints of ranges, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the present disclosure are approximations, unless otherwise indicated the numerical values set forth in the specific examples are reported as precisely as possible. Any numerical value, however, inherently contains certain errors necessarily resulting from the standard deviation found in their respective testing measurements.

### EXAMPLES

### Test Bed

Testing was performed to demonstrate the impact of amine (piperazine) and alkali (potassium) concentration on absorption medium characteristics and various operational parameters of a thermal swing absorption process. The test bed included an absorber column having a 4″ interior diameter, a regenerator column having a 3″ interior diameter, a cross heat exchanger, a kettle reboiler, a flue gas generator, and a product gas dryer. These components were arranged to form a thermal swing absorption system having the general configuration shown in FIG. 1. The test bed also included instrumentation for measuring flows, CO₂ and THC concentration, pH, etc. Moreover, instrumentation for measuring the heat input to the boiler was included, which enabled the calculation of the mass and energy balance of the system.

Simulated flue gas was generated with a propane burner. The composition and CO₂ content in the flue gas was adjusted by the addition of other gases to simulate the composition of real flue gas produced by a coal fired plant.

The flue gas entered the absorber column at a flow rate between 8 and 20 scfm. The flue gas transferred CO₂ from the flue gas to the absorption medium as it traveled up the absorber column and through absorber packing, producing a CO₂ rich stream and a scrubbed gas stream. At the same time, piperazine and water was transferred from the absorption medium to the flue gas and was carried away with the scrubbed gas stream. Because CO₂ absorption occurred exothermically, the temperature of the CO₂ rich stream increased as its CO₂ content increased.

The scrubbed gas stream continued traveling upwards through absorber packing. Upon leaving the absorber packing, the scrubbed gas entered the water wash section. Within the water wash section, piperazine was separated from the scrubbed gas by contact with a washing liquid. Total hydrocarbon content of the scrubbed gas stream exiting the water wash section was measured and recorded using a continuous THC analyzer.

The CO₂ rich stream flowed out the bottom of the absorber column, and was pumped through a cross heat exchanger to increase its temperature. After passing through the heat exchanger, the CO₂ rich stream was routed to an entrance of the regenerator column.

The CO₂ rich stream entered an upper portion of the regenerator column and flowed downward. As it flowed downward, the CO₂ rich stream came into countercurrent contact with reboiled steam, i.e., steam produced by boiling absorption medium in the regenerator column. Contact with the steam liberated a vapor containing CO₂ and water from CO₂ rich stream, thereby regenerating the absorption medium. The gross regeneration energy in BTU/lbs CO₂ removed was measured and recorded.

The regenerated absorption medium was removed from the regenerator and routed back to the absorber column through the cross heat exchanger. As the regenerated absorption medium passed through the cross heat exchanger, it was cooled by transferring heat to the CO₂ rich stream exiting the absorber. Ultimately, the regenerated absorption medium was reused in the process.

### Example 1

Testing was performed by changing solution composition while holding the other parameters of the process constant. As the solution composition was changed, CO₂ scrubbing performance and the gross regeneration energy were measured. The results are reported in Table 1 below.

TABLE 1

| Summary | | | | | | |
|---|---|---|---|---|---|---|
| Values | Units | Increasing K | | | Increasing PZ | |
| CO2 Removal | [%] | 74.3 | 76.8 | 76.9 | 91.6 | 90.5 |
| L/G | [gpm/ | 24 | 24 | 24 | 24 | 24 |
| | kacfm] | | | | | |
| Gross | [BTU/ | 2,072 | 2,456 | 2,747 | 1,961 | 1,670 |
| Regeneration | lb CO2] | | | | | |
| energy | | | | | | |
| Absorber | | | | | | |
| Conditions | | | | | | |
| K | [Wt. %] | 2.3 | 4.2 | 9.8 | 2.5 | 2.3 |
| concentration | | | | | | |
| PZ | [Wt. %] | 8.8 | 8.6 | 9.0 | 10.7 | 14.5 |
| concentration | | | | | | |
| MEA | [%] | 0.0 | 0.0 | 0.0 | 0.0 | 0.0 |
| concentration | | | | | | |
| Liquid Feed | [° F.] | 110 | 110 | 109 | 109 | 110 |
| Temp | | | | | | |
| Gas Velocity | [ft/sec] | 2.6 | 2.7 | 2.7 | 2.6 | 2.7 |
| Regenerator | | | | | | |
| Conditions | | | | | | |
| Liquid Feed | [° F.] | 205 | 204 | 204 | 205 | 205 |
| Temp | | | | | | |
| Pressure | [psia] | 28.2 | 28.3 | 28.4 | 28.4 | 28.4 |

As shown, as potassium increased from 2.3 to 9.8 wt % in an absorption medium containing ˜9 wt % piperazine, regeneration energy increased from 2072 to 2747 BTU/lb CO₂ removed—a 25% increase in regeneration energy over the range tested. In contrast, regeneration energy in an absorption media containing about 2.5 weight % potassium decreased from 2072 to 1670 BTU/lb CO₂ removed as piperazine concentration was increased from 8.8 to 14.5 wt %. Moreover, the solutions containing greater than 10 weight % piperazine and about 2.5 weight % potassium exhibited markedly better CO₂ absorption.

### Example 2

Additional testing was conducted to compare the performance of absorption media containing 22-30 wt. % piperazine and 2-2.2 wt. % potassium to a conventional CO₂ absorption medium containing 26 wt % monoethanolamine (MEA). Each solution was used to scrub CO₂ from simulated flue gas under nearly identical process conditions. Gross regeneration energy, total hydrocarbons (THC), and other processing parameters were measured. The results are reported in Table 2.

TABLE 2

| Summary | | | | | | |
|---|---|---|---|---|---|---|
| Values | Units | Value | | | | |
| CO2 Removal | [%] | 91.3 | 89.9 | 90.6 | 89.6 | 90.2 |
| L/G | [gpm/kacfm] | 15 | 15 | 15.3 | 15.1 | 16.3 |
| Gross | [BTU/lb | 1,174 | 1,312 | 1,222 | 1,188 | 1,159 |
| Regeneration | CO2] | | | | | |
| energy | | | | | | |
| Absorber | | | | | | |
| Conditions | | | | | | |
| Solution | [Wt. %] | 22 PZ/ | 26 MEA | 24.4PZ/ | 25.8PZ/ | 30PZ/ |
| Composition | | 2K | | 2.1K | 2.2K | 2K |
| THC | [ppm] | 32 | 320 | 39.9 | N/A | 102 |
| Gas Velocity | [ft/sec] | 3.7 | 3.7 | 3.6 | 3.2 | 3.7 |
| L/G | [gpm/kacfm] | 15 | 15 | 15.3 | 15.1 | 16.3 |
| Regenerator | | | | | | |
| Conditions | | | | | | |
| Liquid Flow | [gpm] | 0.34 | 0.34 | 0.33 | 0.29 | 0.36 |
| pH | | 9.0 | 8.9 | 8.92 | 8.8 | 8.61 |
| Liquid Feed | [° F.] | 220 | 220 | 219.5 | 220.4 | 220.2 |
| Temp | | | | | | |
| Liquid Outlet | [° F.] | 253 | 253 | 253.0 | 252.4 | 263.2 |
| Temp | | | | | | |
| Regen Delta T | [° F.] | 33 | 33 | 34 | 32 | 43 |
| Pressure | [psia] | 28.2 | 28.3 | 28.3 | 28.5 | 33.4 |

As shown, the MEA absorption medium required 1312 btu/lb CO₂ removed, compared to about 1200 btu/lb CO₂ removed for the piperazine/potassium absorption media. That is, the piperazine/potassium absorption medium required approximately 11% less energy to regenerate than the comparative MEA absorption medium.

### Example 3

Further testing was performed to evaluate the impact of absorber L/G on CO₂ removal and gross regeneration energy using an absorption medium containing 22 wt. % piperazine and 2 wt. % potassium. The results are reported in Table 3 below. As shown, by decreasing absorber L/G from 24 to 19 gpm/kacfm, the gross regeneration energy was reduced from 1902 to 1744 BTU/lb CO₂ removed without a significant impact on CO₂ removal.

TABLE 3

| Summary | | | | |
|---|---|---|---|---|
| Values | Units | Value | | |
| CO2 Removal | [%] | 90.2 | 90.9 | 88.4 |
| L/G | [gpm/kacfm] | 24 | 22 | 19 |
| Gross | [BTU/lb CO2] | 1,902 | 1,836 | 1,744 |
| Regeneration | | | | |
| energy | | | | |
| Absorber | | | | |
| Conditions | | | | |
| Solution Comp. | [Wt. %] | 22 PZ/ | 22 PZ/ | 22 PZ/ |
| | | 2 K | 2 K | 2 K |
| Inlet pH | | 9.7 | 9.8 | 9.8 |
| Liquid Feed | [° F.] | 109 | 111 | 112 |
| Temp | | | | |
| Regenerator | | | | |
| Conditions | | | | |
| pH | | 9.1 | 9.1 | 8.9 |
| Liquid Feed | [° F.] | 206 | 206 | 205 |
| Temp | | | | |
| Liquid Outlet | [° F.] | 268 | 270 | 271 |
| Temp | | | | |
| Regen Delta T | [° F.] | 62 | 65 | 66 |
| Pressure | [psia] | 39.5 | 39.5 | 39.4 |

### Example 4

Testing was also performed to evaluate the operating conditions on the removal of THC with a water wash. An aqueous absorption medium containing 22 wt % piperazine and 2 wt % potassium was used to perform these tests.

In a first set of experiments, absorber conditions were held constant to maintain a constant THC concentration at the inlet to the water wash of about 30 ppm. The L/G of the water wash was increased from 15 to 39 gpm/kacfm, and the THC content of the scrubbed gas stream leaving the water wash was measured. As shown in Table 4 below, the increase in water wash L/G had little impact on the THC concentration in the scrubbed gas stream leaving the water wash. Indeed, under all conditions the THC leaving the water wash column was between 8 and 15 ppm.

TABLE 4

| Summary | | | | | | | | |
|---|---|---|---|---|---|---|---|---|
| Values | Units | Value | | | | | | |
| CO₂ removal | [%] | 90.9 | 92.0 | 92.1 | 89.9 | 92.0 | 92.1 | 91.8 |
| Absorber | | | | | | | | |
| Conditions | | | | | | | | |
| L/G | [gpm/kacfm] | 15 | 15 | 15 | 15 | 15 | 15 | 15 |
| (absorber) | | | | | | | | |
| Solution | [%] | 22 PZ | 22 PZ | 22 PZ | 22 PZ | 22 PZ | 22 PZ | 22 PZ |
| Composition | | 2K | 2K | 2K | 2K | 2K | 2K | 2K |
| Liquid Feed | [° F.] | 109 | 110 | 110 | 110 | 110 | 110 | 110 |
| Temp. | | | | | | | | |
| THC | [ppm] | 27 | 31 | 30 | 28 | 32 | 33 | 33 |
| Gas Velocaty | [ft/sec] | 3.7 | 3.7 | 3.7 | 3.7 | 3.7 | 3.7 | 3.7 |
| Water Wash | | | | | | | | |
| Conditions | | | | | | | | |
| Liquid Feed | [° F.] | 109 | 110 | 110 | 110 | 110 | 110 | 110 |
| Temp | | | | | | | | |
| Inlet PZ | [%] | 0.2 | 0.2 | 0.2 | 0.2 | 0.2 | 0.2 | 0.2 |
| Inlet K | [%] | 0.0 | 0.0 | 0.0 | 0.0 | 0.0 | 0.0 | 0.0 |
| Feed pH | | ~7.5 | ~7.5 | ~7.5 | ~7.5 | ~7.5 | ~7.5 | ~7.5 |
| Outlet THC | [ppm] | 8.2 | 9.7 | 11.1 | 13.0 | 13.1 | 13.7 | 14.2 |
| L/G | [gpm/kacfm) | 15 | 18 | 20 | 25 | 32 | 34 | 39 |
| (water wash) | | | | | | | | |

In a second set of experiments, absorber conditions were adjusted to change the concentration of THC entering the water wash section. The THC ranged from 9 to 28 ppm. L/G of the water wash was then varied from 47 to 54 GPM/kacfm, and the effect on THC removal was measured. As shown in Table 5 below, the percent THC removed by the water wash ranged from about 58 to about 74%, regardless of inlet THC concentration and water wash L/G.

TABLE 5

| Summary Values | Units | Value | | |
|---|---|---|---|---|
| CO2 Removal | [%] | 91.7 | 91.2 | 92.0 |
| L/G | [gpm/kacfm] | 15 | 18 | 22 |
| % THC removed | [%] | 62.8 | 58.8 | 74.0 |
| Absorber Conditions | | | | |
| Solution composition | [%] | 22 PZ/2 K | 22 PZ/2 K | 22 PZ/2 K |
| Liquid Feed Temp | [° F.] | 109 | 110 | 110 |
| THC | [ppm] | 28 | 9 | 10 |
| Gas Velocity | [ft/sec] | 3.7 | 3.1 | 2.6 |
| Water Wash | | | | |
| Conditions | | | | |
| Liquid Feed Temp | [° F.] | 110 | 111 | 111 |
| Inlet Pz | [%] | 0.2 | 0.2 | 0.2 |
| Inlet K | [%] | 0.0 | 0.0 | 0.0 |
| Feed pH | 0 | ~7.5 | ~7.5 | ~7.5 |
| L/G | [gpm/kacfm) | 45 | 54 | 47 |
| Outlet THC | [ppm] | 10.4 | 3.7 | 3.4 |

In a final set of experiments, absorber conditions were held constant to maintain an inlet THC of about 26-33 ppm. The water wash conditions were also held largely constant. 1.3 to 2.6 wt % of potassium hydroxide was added to the washing liquid to maintain the pH of the washing liquid at about 9-10, and the effect on THC removal was recorded. The results are shown in Table 6 below.

TABLE 6

| Summary Values | Units | Value | | |
|---|---|---|---|---|
| CO2 Removal | [%] | 93.2 | 89.8 | 91.9 |
| L/G | [gpm/kacfm] | 15 | 15 | 15 |
| % THC removed | % | 98.9 | 98.0 | 99.1 |
| Absorber | | | | |
| Solution | [%] | 22 PZ/2 K | 22 PZ/2 K | 22 PZ/2 K |
| Liquid Feed Temp | [° F.] | 109 | 110 | 110 |
| THC | [ppm] | 28 | 26 | 33 |
| Gas Velocity | [ft/sec] | 3.7 | 3.7 | 3.7 |
| Water Wash | | | | |
| Liquid Feed Temp | [° F.] | 111 | 125 | 127 |
| Inlet Pz | [%] | 0.0 | 0.7 | 0.6 |
| Inlet K | [%] | 2.0 | 2.6 | 1.3 |
| Feed pH | | 9.9 | 9.3 | 9.3 |
| L/G | [gpm/kacfm) | 45 | 45 | 45 |
| Outlet THC | [ppm] | 0.3 | 0.5 | 0.3 |

As shown, the washing liquid containing 1-2.5 wt % of potassium was able to consistently remove 98% or more of the total hydrocarbons from the scrubbed gas stream, regardless of inlet THC concentration. Indeed, outlet THC concentrations lower than 0.5 ppm were measured, relative to the outlet THC concentrations in gas streams washed with a washing liquid that did not contain potassium (compare Tables 5 and 6 above).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An aqueous absorption medium, comprising:
from about 12 to about 30 weight % piperazine;
from greater than 0 to about 3.0 weight % of at least one alkali ion of at least one alkali salt; and
water.

2. The aqueous absorption medium of claim 1, wherein piperazine is present in an amount ranging from about 15 to about 28 weight %.

3. The aqueous absorption medium of claim 2, wherein piperazine is present in an amount ranging from about 20 to about 26 weight %.

4. (canceled)

5. The aqueous absorption medium of claim 1, wherein said at least one alkali ion is chosen from potassium ions, lithium ions, sodium ions, and mixtures thereof.

6. The aqueous absorption medium of claim 5, wherein said at least one alkali ion is chosen from potassium ions, and is present in an amount ranging from about 0.5 to about 3 weight %.

7. The aqueous absorption medium of claim 6, wherein said at least one alkali ion is present in an amount ranging from about 1.5 to about 2.5 weight %.

8. (canceled)

9. The aqueous absorption medium of claim 1, wherein:
piperazine is present in an amount ranging from about 20 to about 26 weight %; and
said at least one alkali ion is chosen from potassium ions, lithium ions, sodium ions, and mixtures thereof, and is present in an amount ranging from about 1.5 to about 2.5 weight %.

10. (canceled)

11. (canceled)

12. (canceled)

13. The aqueous absorption medium of claim 1, further comprising at least one antifoam agent.

14. The aqueous absorption medium of claim 1, further comprising from greater than 0 to less than 1 weight % of a polyhydric alcohol, monohydric alcohol, or combination thereof.

15. The aqueous absorption medium of claim 1, wherein the weight % ratio of piperazine to at least one alkali ion ranges from about 4.0:1.0 to about 12.5:1.0.

16. (canceled)

17. (canceled)

18. A method, comprising:
contacting a gas stream comprising CO₂ with an aqueous absorption medium to form an aqueous absolution medium rich in CO₂ and a scrubbed gas stream; and
stripping CO₂ from the aqueous absorption medium rich in CO₂;
wherein the aqueous absorption medium comprises:
from about 12 to about 30 weight % piperazine;
from greater than 0 to about 3.0 weight % of at least one alkali ion of at least one alkali salt; and
water.

19. The method of claim 18, wherein the aqueous absorption medium comprises piperazine in an amount ranging from about 15 to about 28 weight %.

20. (canceled)

21. The method of claim 19, wherein aqueous absorption medium comprises piperazine in an amount ranging from about 20 to about 26 weight %.

22. The method of claim 18, wherein said at least one alkali ion is chosen from potassium ions, lithium ions, sodium ions, and mixtures thereof.

23. The method of claim 22, wherein said at least one alkali ion is chosen from potassium ions, and is present in the aqueous absorption medium in an amount ranging from about 1.5 to about 2.5 weight %.

24. (canceled)

25. (canceled)

26. The method of claim 18, wherein said aqueous absorption medium comprises piperazine in an amount ranging from about 20 to about 26 weight %; said least one alkali ion is chosen from potassium ions, lithium ions, sodium ions, and mixtures thereof; and said at least one alkali ion is present in the aqueous absorption medium in an amount ranging from about 1 to about 2.5 weight %.

27. (canceled)

28. The method of claim 18, wherein a net regeneration energy consumed during said contacting and said stripping is less than 1300 BTU per pound of CO₂ removed.

29-48. (canceled)

49. The method of claim 18, further comprising washing said scrubbed gas stream with an aqueous washing liquid comprising potassium ions in an amount ranging from about 0.5 to amount 3.0 weight %

50. The method of claim 49, wherein a total hydrocarbon content of the scrubbed gas stream after said washing is less than about 0.5 ppm.

51. The method of claim 18, further comprising removing at least one impurity from the aqueous absorption medium with an ion exchange process.
